(19) United States
(12) Patent Application Publication
(10) Pub. No.: US 2013/0251344 A1
(43) Pub. Date: Sep. 26, 2013

(54) Manipulation of User Experience State

(71) Applicants: Joseph M. Joy, Redmond, WA (US); Narendranath Datha, Bangalore (IN); Tanuja Abhay Joshi, Pune (IN); Sriram K. Rajamani, Bangalore (IN); Eric J. Stollnitz, Kirkland, WA (US)

(72) Inventors: Joseph M. Joy, Redmond, WA (US); Narendranath Datha, Bangalore (IN); Tanuja Abhay Joshi, Pune (IN); Sriram K. Rajamani, Bangalore (IN); Eric J. Stollnitz, Kirkland, WA (US)

(73) Assignee: MICROSOFT CORPORATION, Redmond, WA (US)

(21) Appl. No.: 13/429,093

(22) Filed: Mar. 23, 2012

(51) Int. Cl. G11B 27/00

(52) U.S. Cl. 386/285; 386/E05.028

(57) ABSTRACT

Techniques for manipulation of user experience state are described. A user experience can include various types of content that a user may consume, such as video content, images, audio content, text documents, and so on. Further, a “composition” can be created using various combinations of user experiences, such as still images inset to video content, a navigable map presented with images of geographical locations associated with the map, and so on. In implementations, techniques enable user experiences included as part of a composition to interact such that behaviors associated with one user experience can affect another user experience, and vice-versa.

### BACKGROUND

Today's computer user has access to a wide variety of content, such as text documents, video content, audio content, images, and so on. While instances of content can be individually consumed by a user, multiple instances of content can also be combined to provide a more diverse and complex user experience. For example, multiple digital images can be “stitched” together to provide a large panorama, which is a visual environment that can be navigated (e.g., panned, zoomed, and so on) by a user. Complex user experiences can also be created by composing various types of content and services, such as associating multiple panoramas with their locations on an online map. Building such compositions, as well as scripting these compound user experiences and services, typically requires custom programming for each instance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for manipulation of user experience state are described. A user experience can include various types of content that a user may consume, such as video content, images, audio content, text documents, interactive games, and so on, as well as software and services that can be employed to implement a user experience. Further, a “composition” can be created using various combinations of user experiences, such as still images inset to video content, a navigable map presented with images of geographical locations associated with the map, and so on.

In implementations, techniques enable the state of individual user experiences and composed user experiences (e.g., compositions) to be represented as data, and the behavior of user experiences to be manipulated and scripted declaratively. For example, behaviors of user experiences and/or compositions can be represented as expressions and manipulations of data, as opposed to manipulations of software objects. Techniques discussed herein can also enable user experiences included as part of a composition to interact such that behaviors associated with one user experience can affect another user experience, and vice-versa.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example operating scenario in accordance with one or more embodiments.

FIG. 3 illustrates an example operating scenario in accordance with one or more embodiments.

FIG. 4 illustrates an example state stream in accordance with one or more embodiments.

FIG. 5 illustrates an example sliver processing scenario in accordance with one or more embodiments.

FIG. 6 is a flow diagram that describes steps in a method in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 illustrates an example system that includes the computing device as described with reference to FIGS. 1 and 11.

FIG. 11 illustrates various components of an example device that can be implemented as any type of portable and/or computer device as described with reference to FIGS. 1 and 10 to implement embodiments of the techniques described herein.

### DETAILED DESCRIPTION

Overview

Techniques for manipulation of user experience state are described. A user experience can include various types of content that a user may consume, such as video content, images, audio content, text documents, interactive games (e.g., a video game), and so on, as well as software and services that can be employed to implement a user experience. Further, a “composition” can be created using various combinations of user experiences, such as still images inset to video content, a navigable map presented with images of geographical locations associated with the map, and so on.

In implementations, techniques enable the state of individual user experiences and composed user experiences (e.g., compositions) to be represented as data, and the behavior of user experiences to be manipulated and scripted declaratively. For example, behaviors of user experiences and/or compositions can be represented as expressions and manipulations of data, as opposed to manipulations of software objects. Techniques discussed herein can also enable user experiences included as part of a composition to interact such that behaviors associated with one user experience can affect another user experience, and vice-versa.

In at least some embodiments, interaction between user experiences can be enabled by characterizing progression through user experiences as an evolution of “small state” over time. “Small state” refers to data that represents the logical state of user experiences at particular times in the user experiences, such as a navigation state through a map user experience, a selection state of selectable objects in a user experience, and so on. In implementations, small state may be organized into multiple data constructs referred to as “state slivers.” In at least some embodiments, a state sliver can define a logical state of a coherent subset of properties of a user experience, and different kinds of user experiences may share common and standardized state sliver definitions. Thus, state slivers can provide ways in which information about small state can be propagated between user experiences to enable the user experiences to interact with each other or with other entities, such as software. For example, a change in the state of one user experience (e.g., a user zooming in on a map location) can be propagated to a different user experience as one or more state slivers. The different user experience can respond to the state sliver, such as by presenting one or more images associated with the zoomed map location.

In implementations, collections of state slivers can be provided that include one or more constituent standardized state slivers. For example, a view collection can be provided that enables various aspects of a user experience that is being presented to a user to be described. The view collection can include a number of different state slivers, such as a region sliver that describes a portion of a two-dimensional (2D) and/or three dimensional (3D) space to be displayed, a document sliver that enables various aspects of a paginated document view to be described, and so on. Thus, a wide variety of different user experiences can utilize collections of standardized and/or customized state slivers to represent their logical configurations, and to manipulate these configurations.

Further to such embodiments, a representation of the evolution of small state as a function of time can be used to script, or automate, the behavior of a user experience over a period of time, wherein aspects of a user experience can be determined by the contents of the small state representation. For example, a series of slivers, each accompanied by a time offset and interpolation hints, can determine camera parameters for an automated timed fly-through path over an online map user experience.

Further to at least some embodiments, user interaction with a user experience can be represented by an evolution of small state, such as via a series of state sliver updates with optional accompanying time signatures. For example, a user interaction with an online map user experience can be characterized as a series of region state slivers, each representing new view (e.g., camera) parameters corresponding to a map view presented to the user in response to the user's interaction.

This stream of information representing the evolution of small state can be fed to other components, which can use the information to perform various tasks. For example, the stream of region sliver updates can be sent to an external service to log the user's behavior for analysis. Alternatively or additionally, the stream of region sliver updates could be transformed, and the transformed result sent to an image gallery user experience. The image gallery user experience may use information from the region sliver updates to present images that are relevant to a region of the map viewed by the user. Thus, state slivers can be utilized by compositions in a user interaction mode, and state slivers can be used to propagate state information to another user experience and/or entity, such as an application and/or external service that can utilize information from a state sliver to perform various tasks.

In at least some embodiments, a state sliver emitted by a user experience can be transformed before it is propagated to a different user experience. For example, one or more transformation rules can be applied to data included as part of a state sliver to transform the data. The transformed data can be transferred to a different user experience, which can use the transformed data to effect one or more changes to aspects of the different user experience. Examples of state sliver transformation and transformation rules are discussed in detail below.

In the following discussion, an example environment is first described that is operable to employ techniques for manipulation of user experience state described herein. Next, a section entitled “Example Operating Scenarios” describes some example operating scenarios in accordance with one or more embodiments. Following this, a section entitled “Declarative Implementations” describes example embodiments in which declarative programming techniques may be utilized. Next, a section entitled “State Slivers” describes some example state slivers and example implementations of state slivers in accordance with one or more embodiments. Following this, a section entitled “Streams of State Slivers” describes an example state stream that includes state slivers in accordance with one or more embodiments. Next, a section entitled “Processing State Slivers” describes an example state sliver processing scenario in accordance with one or more embodiments. Following this, a section entitled “State Sliver Transformations” describes some example state sliver transformations and transformation rules in accordance with one or more embodiments. Next, a section entitled “Example Methods” describes some example methods in accordance with one or more embodiments. Following this, a section entitled “Partial Updates to State Slivers” describes some example embodiments in which state slivers may be used to determine part or all of the state of the user experience. Finally, an example system and device are described that are operable to employ techniques discussed herein in accordance with one or more embodiments.

### Example Environment

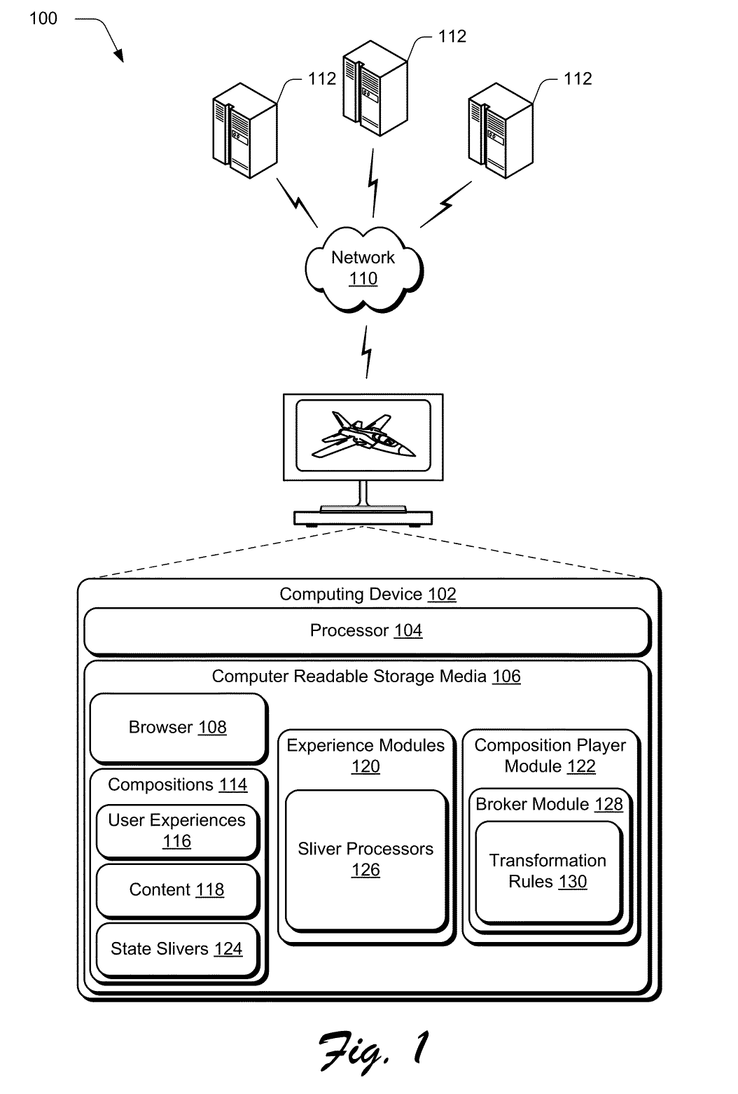

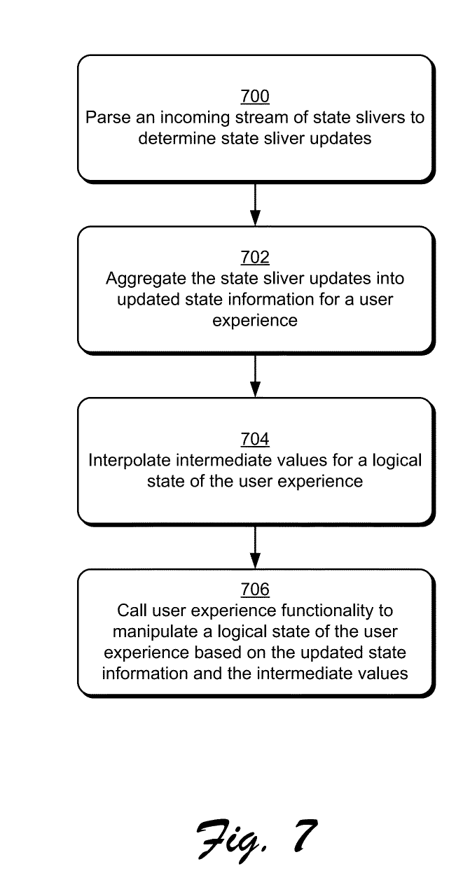

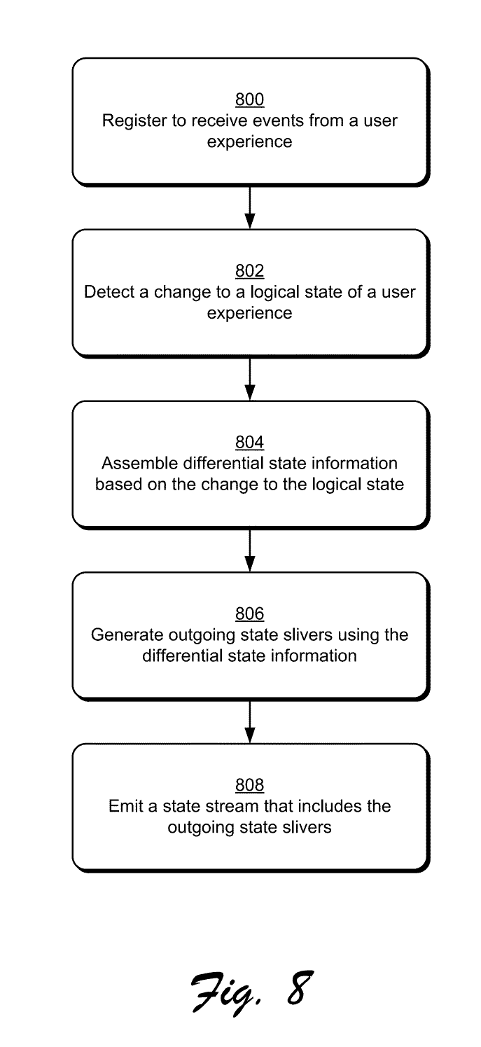

FIG. 1 is an illustration of an environment 100 in an example implementation that is operable to employ techniques for manipulation of user experience state. Environment 100 includes a computing device 102 having one or more processors 104, one or more computer-readable storage media 106, and a browser 108 that resides on the computer-readable storage media 106 and which is executable by the processor 104. Computing device 102 can be embodied as any suitable computing device such as, by way of example and not limitation, a desktop computer, a portable computer, a handheld computer such as a personal digital assistant (PDA), mobile phone, tablet computer, and the like. One of a variety of different examples of a computing device 102 is shown and described below in FIGS. 7 and 8.

The browser 108 is representative of functionality (e.g., a web browser) that is configured to navigate via a network 110 to access one or more web resources 112. Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be configured to include multiple networks.

The browser 108, for instance, may be configured to navigate via the network 110 to interact with content available from the web resources 112 as well as communicate data to the one or more web resources 112, e.g., perform downloads and uploads. The web resources 112 may include any suitable computing resource that is configured to provide content that is accessible via the network 110. Examples of such content include web pages, text content, video, audio, and so on.

Although embodiments are discussed herein with reference to the browser 108, other applications and/or utilities can be used in addition to or instead of the browser 108. For example, implementations can utilize a custom built application that is specifically configured to implement techniques discussed herein.

Also illustrated are one or more compositions 114 which are stored on the computer-readable storage media 106 and which include one or more user experiences 116 and content 118. The user experiences 116 are representative of functionality to reference instances of the content 118 such that the content can be presented to a user. In implementations, the user experiences 116 can present instances of the content 118 to a user in a manner that enables user interaction. The content 118 can include a variety of different types of content, such as video content, images, audio content, and so on. The content 118 may also include references to content that can be retrieved from another location, such as the web resources 112. Further to embodiments, the user experiences 116 and/or the content 118 may be downloaded from the web resources 112 and cached locally on the computing device 102.

The compositions 114 are representative of collections of the user experiences 116 that can be “played” for a user, e.g., displayed and/or otherwise presented via the browser 108. In implementations, one or more of the compositions 114 may include a different collection of user experiences than others of the compositions such that some or all of the compositions can provide a tailored user experience.

Further stored on the computer-readable storage media 106 are one or more experience modules 120, which are representative of functionality to process and/or manage the user experiences 116 such that the user experiences can be presented to a user. In implementations, the experience modules 120 can include a variety of different applications and/or utilities, such as a map control, a video player control, an audio player control, and so on.

Also illustrated is a composition player module 122 which is stored on the computer-readable storage media 106 and which is representative of functionality to process and/or manage the compositions 114. In implementations, the composition player module 122 can enable the compositions 114 to be played by leveraging the experience modules 120 to handle playing of individual of the user experiences 116 included as part of the compositions. Thus, the composition player module 122 can serve as a coordinator that retrieves data from the compositions 114 and accesses various functionalities (e.g., the experience modules 120) to enable the compositions to be presented to a user.

Also included as part of the compositions 114 are state slivers 124, which are representative of data constructs that provide ways in which state information associated with the user experiences 116 can be propagated between various entities of the environment 100. Further aspects of the state slivers 124 are discussed in more detail below.

To enable the state slivers 124 to be generated and/or processed, the experience modules 120 include one or more sliver processors 126. The sliver processors 126 are representative of functionality to generate streams of state slivers that encode the logical state of a user experience (e.g., as a function of time), as well as consume streams of state slivers received from an external source. In implementations, streams of state slivers may be stored as data to enable automated scripting of “fly-throughs” of user experiences. An example architecture for the sliver processor 126 is discussed in more detail below.

To assist in propagating information contained in streams of state slivers to various entities, the composition player module 122 includes a broker module 128, which in turn includes one or more transformation rules 130. The broker module 128 is representative of functionality to receive the state slivers 124 (e.g., from the user experiences 116 and/or the experience modules 120) and, in at least some implementations, apply the transformation rules 130 to data from the state slivers. The broker module 128 may also transmit data from the state slivers 124 that has been transformed to the experience modules 120 and/or other entities.

In implementations, the broker module 128 can access external content and/or services as part of processing the state slivers 124. For example, the broker module 128 can leverage data and/or processing services that reside elsewhere on the computing device 102 and/or the web resources 112 as part of processing the state slivers 124.

Generally, any of the functions described herein can be implemented using software, firmware, hardware (e.g., fixed logic circuitry), or a combination of these implementations. The terms “composition,” “module,” “functionality,” and “logic” as used herein generally represent software, firmware, hardware, or a combination thereof. In the case of a software implementation, the composition, module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium or other transitory medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having described an example environment, consider now a discussion of some example operating scenarios in accordance with one or more embodiments.

### Example Operating Scenarios

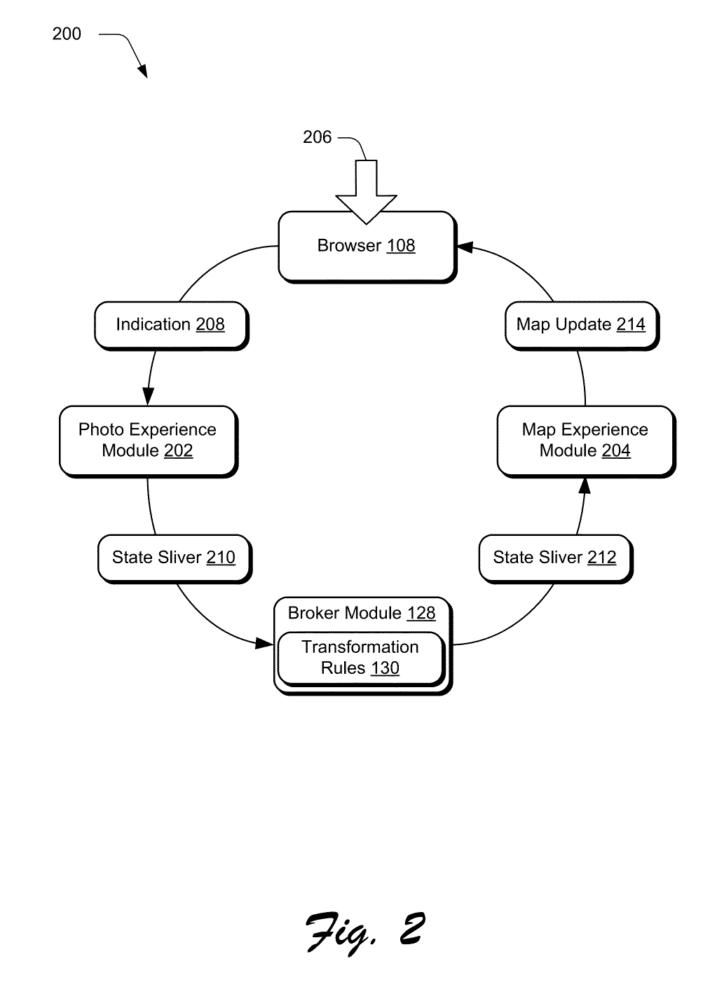

FIG. 2 illustrates an example operating scenario in accordance with one or more embodiments, generally at 200. Operating scenario 200 includes the browser 108 and the broker module 128, discussed above with reference to environment 100. Operating scenario 200 further includes a photo experience module 202 and a map experience module 204, which are examples of the experience modules 120, discussed above. In implementations, the photo experience module 202 is configured to enable photographs and other images to be presented to a user, e.g., via the browser 108. The map experience module is representative of functionality to enable a user to view and navigate various maps, e.g., via the browser 108.

Further to the operating scenario 200, a user input 206 is provided to the browser 108. For example, a user can provide input to a graphical user interface of the browser 108, such as a selection of one or more images managed by the photo experience module 202 and displayed in the interface. In response to the user input 206, the browser 108 sends an indication 208 of the user input 206 to the photo experience module 202. In implementations, the indication 208 can include various information associated with the user input 206. For example, the indication 208 can identify one or one or more images that were selected and/or requested by a user.

In response to receiving the indication 208, the photo experience module 202 generates a state sliver 210 and transmits the state sliver to the broker module 128. In implementations, the photo experience module 202 generates the state sliver 210 based on various information about the user input 206, such as identification information about a selected image, geographic information associated with a selected image, and so on. Detailed discussions of generating and transmitting state slivers are discussed further below.

Further to the operating scenario 200, the broker module 128 receives the state sliver 210 and applies one or more of the transformation rules 130 to the state sliver 210. In implementations, the transformation rules 130 include various algorithms, conversion tables, and so on, that can be applied to data received as part of a state sliver. Example transformation rules and their implementations are discussed in more detail below.

The broker module 128 generates a state sliver 212, which includes data from the state sliver 210 that has been converted, transformed, and/or manipulated via the transformation rules 130. In implementations, the application of the transformation rules 130 to the state sliver 210 causes data from the state sliver 210 to be converted into a form that can be recognized and utilized by other entities, e.g., the map experience module 204.

Continuing with the operating scenario 200, the state sliver 212 is passed to the map experience module 204. The map experience module 204 processes the state sliver 212, such as by inspecting the state sliver 212 for data that can be utilized by the map experience module 204. The map experience module 204 generates a map update 214, which it provides to the browser 108. For instance, the map update 214 can include an update to a map view that is displayed via the browser 108. The map update can cause a map view managed by the map experience module 204 to navigate to a geographical location that corresponds to a photograph selected via the user input 206, such as a geographical location at which the photograph was taken. While the operating scenario 200 illustrates state slivers as being transmitted, received, and processed by experience modules and broker modules, this is not intended to be limiting. As discussed elsewhere herein, state slivers can be transmitted, received, and processed by a variety of different entities to implement techniques discussed herein. Detailed discussions of processing and utilizing state slivers to affect user experiences are presented below. As a further example of transformation of user experiences using state slivers, consider the following example scenario.

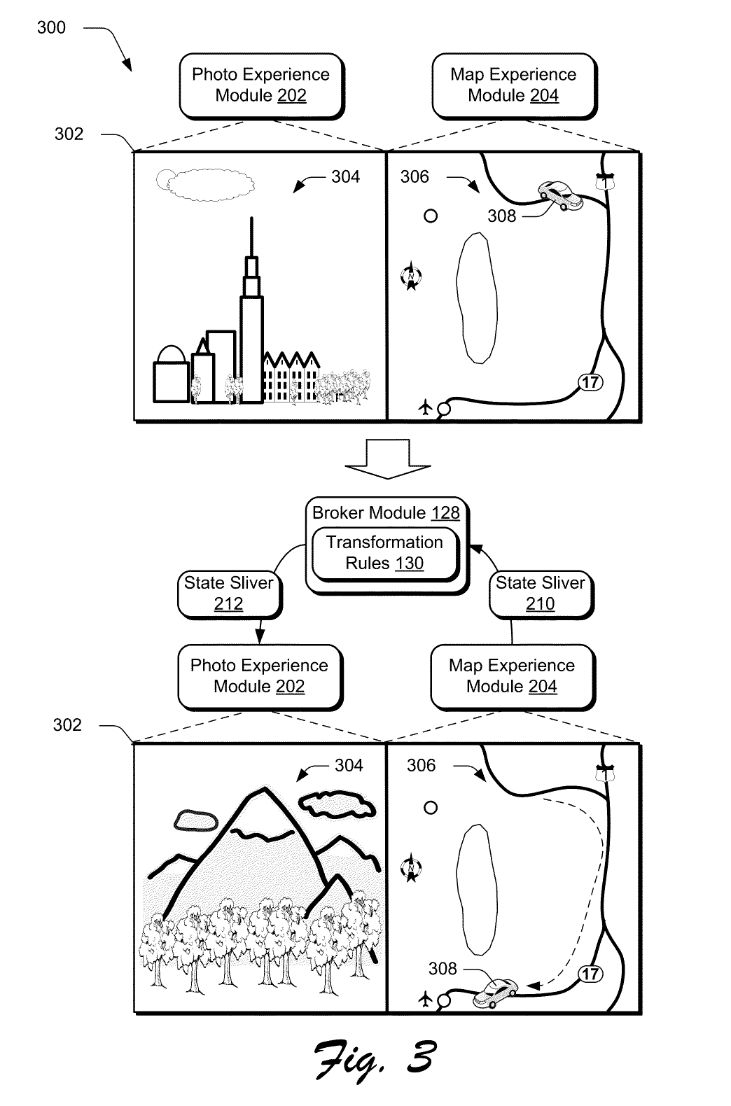

FIG. 3 illustrates an example operating scenario in accordance with one or more embodiments, generally at 300. In implementations, the operating scenario 300 illustrates a graphic example of the operating scenario 200, discussed above. In the upper portion of the operating scenario 300 is illustrated a graphical user interface (GUI) 302. In implementations, the GUI 302 can be implemented by a variety of different applications, such as the browser 108. As part of the GUI 302 is a user experience 304 and a user experience 306, which include respective content that is presented via the GUI 302. As illustrated, the user experience 304 is managed by the photo experience module 202, and the user experience 306 is managed by the map experience module 204.

Continuing to the lower portion of the operating scenario 300, a user provides input to the user experience 306 by manipulating an icon 308. For example, a user drags the icon 308 (e.g., using any suitable type of user input method) within the portion of the GUI 302 occupied by the user experience 306. Alternatively or additionally, the icon 308 can move to the new position in the GUI 302 in response to an execution of a scripted event, as discussed elsewhere herein.

In response to the manipulation of the icon 308 within the user experience 306, the map experience module 204 generates the state sliver 210, as discussed above with reference to operating scenario 200. The state sliver 210 includes information that represents the logical state of the user experience 306, such as location information for a location within the user experience 306 to which the icon 308 is manipulated and/or other information about the user input to the user experience 306. The location information can include geographical coordinates (e.g., latitude, longitude, and so on), screen coordinates, an identifier associated with the icon, and so on.

Continuing with the operating scenario 300, the map experience module 204 provides the state sliver 210 to the broker module 128. The broker module applies one or more of the transformation rules 130 to data from the state sliver 210, as discussed in more detail above and below. The broker module 128 generates the state sliver 212, which includes data that results from the application of the one or more transformation rules 130 to the state sliver 210. The state sliver 212 is provided to the photo experience module 202, which uses data from the state sliver 212 to make one or more changes to the user experience 304. For example, the photo experience module 202 can locate (e.g., using location information from the state sliver 210 and/or state sliver 212) a photograph taken at the location in the user experience 306 to which the icon 308 is manipulated. The photograph can be displayed as part of the user experience 304. Thus, as illustrated, state slivers can be used to propagate state information among user experiences and enable user experiences to respond to changes to other user experiences.

Having described example operating scenarios, consider now a discussion of some example declarative implementations in accordance with one or more embodiments.

Declarative Implementations

Techniques discussed herein can enable user experiences and compositions to be created and manipulated using declarative programming techniques. Declarative programming refers generally to techniques whereby a programmer specifies tasks to be performed rather than procedures by which particular tasks may be performed. For example, declarative programming can be contrasted with imperative programming techniques, where a programmer provides specific logic and/or algorithms by which particular tasks can be performed. Examples of declarative programming languages which may be utilized in accordance with one or more embodiments include Cascading Stylesheets (CSS), various markup languages (e.g., Hypertext Markup Language (HTML), extensible stylesheet language transformations (XSLT), and so on), Structured Query Language (SQL), and so on.

The compositions 114 may also be created using declarative programming. For example, a particular composition can include declarative statements that specify relationships between its constituent user experiences. The declarative statements can also specify how the composition and/or its constituent user experiences interact by the transformation and exchange of streams of small state slivers, as detailed later.

Further to such declarative implementations, the composition player module 122 can be configured to script (e.g., interpret and play) pre-computed streams of declaratively-specified state targeting one or more user experiences individually or within compositions. For example, the composition player module 122 can be configured to interpret declarative statements encoded as one or more state slivers 124 and to correspond with the appropriate experience modules 120 to cause the declarative statements to be performed as one or more corresponding tasks. For instance, the composition player module 122 can receive a declarative statement from one of the user experiences 116 to play a certain instance of content specified by the statement encoded as a state sliver 124. The composition player module 122 can transmit the state sliver 124 to the appropriate experience module 120 to cause the instance of content to be played. Thus, in implementations user experiences and/or compositions can be specified as declaratively-specified sequences of slivers and/or content without requiring a user to generate imperative code that specifies how the user experiences and/or compositions are to be played.

Having described example declarative implementations, consider now a discussion of some example state slivers and sliver collections in accordance with one or more embodiments.

State Slivers

As mentioned above, a state sliver is a data construct that represents aspects of the logical state of a user experience. In this document, the term “small state” is used to define the aggregate logical state of a user experience at particular points in time. Small state can be contrasted with the internal state of software modules implementing the user experience, which may be platform specific, and contain references to internal and external objects and services utilized to execute the user experience. In implementations, small state is serializable (e.g., does not reference objects) and includes information to logically represent a state of a user experience. A state sliver can be described as a portion of small state. Examples of state slivers are discussed below.

According to implementations, using standardized formats for state slivers can enable small state information to be propagated between user experiences to enable user experiences to interact as part of a coordinated composition, as well as interact with external entities without utilizing custom event handling code. State slivers can be represented via one or more standardized data formats that can be generated and/or recognized by various entities and applications, such as the broker module 128 and the experience modules 120, discussed above.

In implementations, state slivers can be implemented in discrete data structures known as sliver collections that include one or more slivers per structure. For example, a sliver collection can be represented using the logical form (target, slivers). The target aspect includes information that identifies a particular targetable aspect within a user experience to which the state slivers are targeted. For example, a sliver collection may be targeted at a “view” property of a book reader user experience that controls the zoom level and page view mode of the reader. The slivers aspect includes identifiers for particular state slivers such that the state slivers can be recognized and appropriately routed and/or processed, e.g., by the broker module 128 and the experience module 120. For instance, consider the following example extensible markup language (XML) representation of a sliver collection.

```
<state-update>
<target name=”...”> ... </target>
<slivers>
      <sliver1 ...>...</sliver1>
      <sliver2...>...</sliver2>
      ...
</slivers>
</state-update>
```

This example presents a general structure that can be used to represent state slivers that can be propagated among different entities. In this example, the “target” aspect identifies a particular targetable aspect of a user experience to which state slivers are targeted. Information within the target element can be used to specify additional attributes that can be used to identify a target entity. The “sliver1” and “sliver2” represent the actual state slivers that are included in the sliver collection, specific examples of which are discussed below.

As a more specific example, consider the following sliver collection.

<state-update>
<target name=“view”/>
<slivers>
<region>
<center>1.0, 2.0</center>
<extent>2.0, 2.0</extent>
</region>
<mapstyle style=″road″/>
</slivers>
</state-update>

In this example, the “target name” aspect discussed above is the “view” component of one or more user experiences. For example, the state slivers included in the above sliver collection can be used to modify one or more view aspects (e.g., visual aspects) of a user experience. This example sliver collection includes two state slivers, a “region” state sliver and a “mapstyle” state sliver. The “region” state sliver specifies a mapping from a 2D manifold representation of a map to a position on a display device. For example, the section of the map specified by <center> and <extent> are mapped to a display device. As used herein, the term “manifold” refers to a topological space (e.g., a 2D map, an image, and a panorama) that, in implementations, exhibits Euclidean properties.

The “mapstyle” state sliver specifies information related to the style of the map being rendered, in this case it specifies that the “road” style (as opposed to a satellite photo style) is to be employed.

As another example, consider the following sliver collection.

<state-update>
<target name=”EmbeddedContent” ItemId=”133”GroupId=”4”/>
<slivers>
<display mode=″expanded″/>
<animate offset=″0.5″ Duration=″2.0″ Play=″true″>
</slivers>
</state-update>

This particular state sliver structure specifies an addressable piece of content embedded within a user experience. For example, the “ItemId” and “GroupId” target attributes identify the specific item, e.g., an item with identifier “123” in a group number 4. The sliver elements set the state of this item to “expanded”, and specify that the contents (which are assumed to be capable of being animated, e.g., a movie) be animated. For example, the child elements specify that the item is to be animated starting at an animation offset of 0.5 seconds for 2.0 seconds, and that the animation is to play, e.g., Play=“true.”

As another example, consider the following sliver collection.

<state-update>
<target name=”filter”/>
<slivers>
<query> monuments</query>
</slivers>
<state-update>

This particular sliver collection specifies a filter that is set for a user experience. For example, the filter specifies which embedded content will be displayed in a user experience by default. It includes a <query> sliver that specifies a search query, in this case returning items from text fields that contain the word “monument.”

As mentioned above, standardized collections of state slivers can be provided that each includes one or more constituent state slivers addressed to a particular target. Updates involving multiple targets can be envisioned as an aggregate of multiple <state-update> elements. As just a few examples, consider the following classifications for sliver collections.

View

Sliver collections targeted at “view” specify information about global visual aspects of a user experience. Such collections can include aspects that may typically be present in document viewers, e.g., reading-mode (1 page, 2 page, and so on), map representation to display mappings, mapping for continuous media (e.g., panoramas, images (including deep zoom images), and so on. One example of a view state sliver structure is discussed above.

In implementations, the “view” target can include additional target attributes. For example, if a user experience includes one or more sub-experiences, the “view” target can identify the one or more sub-experiences using additional attributes. For instance, the additional attributes can include a “role” attribute that identifies a role played by a sub-experience.

As mentioned above, individual sliver elements are named for particular state slivers. The following are just a few examples of slivers that can be implemented as part of the state sliver collection targeted at “view”.

a. <region> payload. This sliver specifies a mapping from a 2D manifold representation of a map to a display window. It can include child elements <center> and <extent>. The <center> element specifies a point in world coordinates that map to a center of a display window. The <extent> element specifies a width in world coordinates that defines a rectangular region in world coordinates that is at a maximum zoom level for a display while remaining visible in the display.

b. <group GroupId=“id1” ItemId=“id2”> payload. The GroupId aspect of this sliver specifies a group from which one or more content items are to be visible in a display. The ItemId aspect identifies an item within the group that is to be visible within a display.

c. <doc PageNum=“3” PageView=“OnePage”/“TwoPage” Thumbnails=“true” Zoom=“0.5”> payload. The PageNum aspect identifies one or more pages in a document that are to be visible. The PageView aspect specifies a display mode for a document, e.g., one page at a time, two pages at a time, and so on. The Thumbnails aspect specifies whether a display of one or more thumbnail images of pages of a document is to be displayed and Zoom specifies a magnification level.

Embedded Content

Sliver collections targeted at “EmbeddedContent” specify the visual state of content that is to be embedded within a user experience. For example, the target can refer to content items from a collection of content items, highlighted content, embedded artifacts in a user experience, and so on. In implementations, the <content> target can include additional attributes that identify a specific content item. The following are a few examples of such attributes:
a. ItemId—a string ID for an item. In implementations, one or more of a SourceId, PageNum, or GroupId can be used to disambiguate between items.
b. SourceId—This attribute specifies a data source for an item. In implementations, the combination (SourceId, ItemId) can specifically identify an item. Further to some implementations, “Highlights” are particular kinds of embedded content used for highlighting other content. For instance, highlights can be included in this <content> specification.
c. PageNum—this attribute can be used for content items embedded in multi-page documents. For example, if the same item is embedded in multiple documents, PageNum can be used to specify which of the documents is to be used to indicate the particular content item.
d. GroupId—this attribute can be used for content items embedded within sub-groups. For example, if the same item is embedded in multiple groups, GroupId can be used to specify from which group the content item is to be retrieved.

The following are a few example state slivers that can be used for the content sliver collection:
a. <display>—this sliver specifies how a content item is to be displayed. For example, the <display> payload can specify one or more display modes, such as Hidden, Minimized, Inset, Expanded, Fullscreen, and so on.
b. <animation>—this sliver specifies if and how a content item is to be animated. For example, a content item can be an item that can play itself, for example, a composition segment, a movie, an animation, and so on. Example values for the <animation> payload include
   1. Offset—This value can be used to indicate a time offset into the animation at which a content item is to begin playing.
   2. Duration—This value can be used to indicate a play time duration for a content item.
   3. Play=true/false—This value can be used to indicate whether a content item is to be played.

Filter

Sliver collections targeted at the “filter” target may be used to determine subsets of content to display within the user experience. It can specify faceted searches, range searches, and so on. The filter state sliver collection includes a <query> state sliver that takes a search string that indicates whether a search is a faceted search, a range search, and so on. The format for specifying a particular search can use one or more standard text search formats, as well as more enhanced formats that support faceted search.

Thus, state slivers can be used to enable interaction between user experiences and/or other entities. For example, a user experience can be adapted to utilize state slivers by mapping various logical states of the user experience to existing state sliver definitions, examples of which are discussed above. Alternatively or additionally, custom state slivers can be defined for aspects of logical state of the user experience that are not covered by a standard state sliver definition. Thus, a particular user experience can implement techniques and/or architectures discussed herein using standard state slivers and, in some embodiments, custom state slivers that can be defined for the particular user experience.

In implementations, the information discussed in the state slivers and/or state sliver collections can be encoded using a variety of different programming languages and/or techniques, such as extensible markup language (XML), JavaScript Object Notation (JSON), and so on.

Having described example state slivers and sliver collections, consider now a discussion of implementations that utilize streams of state slivers in accordance with one or more embodiments.

Streams of State Slivers

In at least some embodiments, the evolution of a user experience as a function of time, e.g., as time progresses, can be represented as a sequence of state slivers.

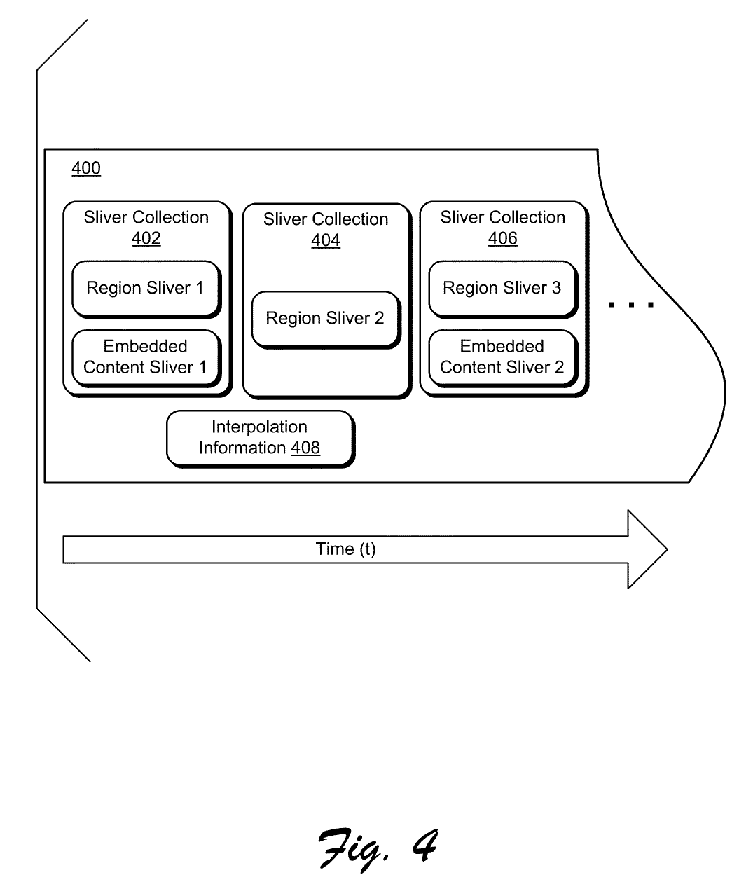

FIG. 4 illustrates a state stream 400, which is one example of a structure that can be implemented to encode a sequence of state slivers that represents an evolution of a small state of the user experience over time. The state stream 400 includes sliver collections 402, 404, and 406, which each include a respective set of one or more state slivers. For example, the sliver collection 402 includes a region sliver 1 and an embedded content sliver 1, examples of which are discussed above. In implementations, the sliver collections can individually include a respective timestamp that indicates when a particular sliver collection occurs, such as with reference to the playing of an associated user experience. For example, the sliver collection 402 can occur at 2 seconds into a user experience, the sliver collection 404 can occur at 7 seconds into the user experience, the sliver collection 406 can occur at 12 seconds into the user experience, and so on.

The state stream 400 further includes interpolation information 408, which specifies how the state of a user experience is to evolve over time. For example, the interpolation information 408 can specify how transitions are to occur between particular sliver collections. Such transitions can include visual transitions, such as fade in and or fade outs, jumping transitions, wipe transitions, zoom in and zoom out transitions, and so. For instance, the interpolation information 408 can specify a fadeout from a visual region associated with the region sliver 1 and a fade in to a visual region associated with the region sliver 2.

In implementations, the interpolation information 408 can be sliver-specific. For example, for one or more of the region slivers, the interpolation information 408 can indicate whether linear interpolation or cubic interpolation techniques are to be used in determining transitions between sliver collections.

In implementations, the state stream 400 can be passed to user experiences to manipulate their state as a function of time, i.e., to script their execution. Furthermore, a user experience can generate streams of state slivers (e.g., the state stream 400) to report the evolution of their state to various entities. These are described in the next section.

Having described an example state stream, consider now a discussion of example ways of processing state slivers in accordance with one or more embodiments.

Processing State Slivers

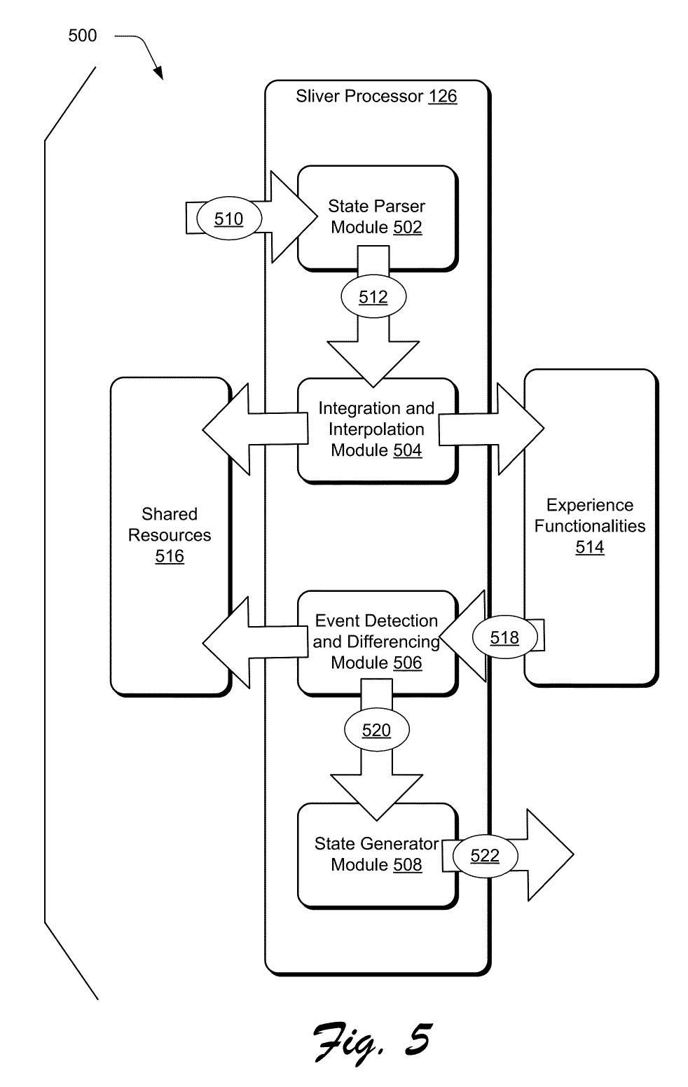

FIG. 5 illustrates an example state sliver processing scenario in accordance with one or more embodiments, generally at 500. The sliver processing scenario 500 includes the sliver processor 126, which is associated with one or more of the experience modules 120. The sliver processor 126 includes and/or has access to a variety of different functionalities, such as a state parser module 502, an integration and interpolation module 504, an event detection and differencing module 506, and a state generator module 508. The functionalities of the sliver processor 126 can be configured to process state slivers based on standard state sliver definitions. Additionally or alternatively, the functionalities can be generated to process custom state slivers that are defined for a particular user experience and/or entity.

Further to the sliver processing scenario 500, the state parser module 502 receives incoming small state 510, such as via a state stream that includes one or more sliver collections. Examples of state streams and sliver collections are discussed in detail elsewhere herein. The incoming small state 510 is parsed by the state parser module 502 to ascertain external state information 512, such as sliver collections and/or state slivers included in the incoming small state 510, interpolation information included in the incoming small state, and so on.

The external state information 512 is provided to the integration and interpolation module 504, which is configured to use the state information to aggregate updates to a state of an associated user experience. The integration and interpolation module 504 is also configured to interpolate the state of a user experience that occurs between sliver collection updates, e.g., updates that are received via streams of state slivers from other sources. Such interpolation can utilize default interpolation information included in content associated with a user experience, interpolation included in a received state stream (e.g., the incoming small state 510), and so on.

Further to the sliver processing scenario 500, the integration and interpolation module 504 invokes one or more experience functionalities 514 to affect one or more changes to an associated user experience. For example, the integration and interpolation module 504 can request, based at least in part on the external state information 512, that the experience functionalities 514 provide one or more instances of content, navigate to one or more regions of content (e.g., locations on a map), and so on. In implementations, the experience functionalities 514 can include application programming interfaces (APIs), methods, subroutines, and so on, associated with a user experience.

In at least some embodiments, the integration and interpolation module 504 can access one or more shared resources 516 to assist in performing various tasks. The shared resources 516 can be accessed by different entities and include a variety of different modules and/or functionalities, such as mathematical interpolation libraries, event scheduling libraries, and so on. The shared resources 516 can also include a timer that can be leveraged by the integration and interpolation module 504 to trigger certain events associated with a user experience. In implementations, the integration and interpolation module 504 can pass state information (e.g., external state information 512) to the shared resources 516, which can perform various processing on the state information before it is passed to the experience functionalities 514.

The event detection and differencing module 506 can detect internal state information for an associated user experience, such as a change to the user experience caused by a scripted event and/or user interaction with user experience. For example, the event detection and differencing module 506 can receive events 518 from the experience functionalities 514 that indicate various state information associated with a user experience. The event detection and differencing module 506 can also maintain versions of various logical states of the user experience (e.g., small states), and can generate difference data 520 that indicates differences between a previous logical state and a current logical state of the user experience, such as indicated by the events 518.

The event detection and differencing module 506 can provide the difference data 520 to the state generator module 508, which can use the difference data 520 to generate state information that can be propagated to other entities. For example, the state generator module 508 can utilize the difference data 520 to generate a state stream 522 that includes state slivers and/or sliver collections that reflect a logical state of an associated user experience. The state stream 522 can be provided to one or more entities for processing, such as the broker module 128, the experience modules 120, the user experiences 116, and so on.

Having discussed example ways of processing state slivers, consider now some example state sliver transformations in accordance with one or more embodiments.

State Sliver Transformations

In implementations, when a user interacts with a user experience, the interaction is can be characterized as an evolution of a small state of the user experience. This “evolution” can be manifested as a stream of state sliver updates that are provided to a broker module, transformed in one way or another, and provided to one or more other user experiences or external services.

In embodiments, the transformation of state slivers and/or state sliver updates can be implemented via declarative transformation rules. Examples of such declarative transformation rules include the transformation rules 130, discussed above with respect to environment 100. Thus, in implementations the transformation rules 130 can include declarative statements that can be interpreted by the broker module 128 to transform data associated with state slivers. This section discusses example ways in which state slivers and the transformation thereof can be leveraged to implement interactions between user experiences.

One-Way Interactions

In implementations, a general interaction between user experiences can be characterized as E₁->B_{D}->E₂, where E₁ is a first user experience, B_{D} is broker functionality (e.g., implemented by the broker module 128) that can utilize information “D” that is external to a state sliver, and E₂ is a second user experience. In this generalized example, B_{D} receives a state sliver collection SSC from E₁ and transforms SSC into SSC′ using one or more transformation techniques. Examples of such transformation techniques are discussed hereafter. The broker module can provide SSC′ to E₂, which can use data from SSC′ to implement one or more changes to its respective user experience. Thus, in implementations, interaction between user experiences can be implemented via state slivers and independent of other forms of interaction.

Identity Transformation

One example of a state sliver transformation can utilize the identity function: I: I(SSC)==SSC. For example, a stream of sliver collection updates can be fed from E₁ via B_{D} unmodified to E₂. One example of this interaction is a “tandem pan/zoom” between user experiences. For example, both E₁ and E₂ can include similar views of similar 2D map content, e.g., image, panorama, and/or video. In the case of video, there can be an additional time dimension. Let us say for this example that E₁ and E₂ are each bound to different instances of content of the same type, and they represent content that is closely related geographically. For example, E₁ and E₂ could be displaying a satellite image of the same geographic region, before (E₁), and after (E₂) a natural disaster.

In this example, the effect of the identify function can be that interactions that occur with E₁ cause corresponding (e.g., tandem) behavior in E₂. For example, if a user pans and/or zooms within E₁, E₂ can pan and zoom in a corresponding way. As a further example, if a user selects an embedded object in E₁, this can cause a corresponding object to be selected in E₂, if such an object exists. As yet a further example, if a user highlights an object in E₁, a corresponding object in E₂ (if such an object exists) can be correspondingly highlighted. In implementations, this scenario can be functional even if instances of content respectively associated with E₁ and E₂ have different sizes and/or aspect ratios, provided that 2D manifold map coordinates for the user experiences are specified in fractional coordinates and/or some other way in which map coordinates between the respective user experiences can be scaled appropriately.

Table-Lookup Based Transformation

In a table-lookup based transformation, the broker functionality discussed above (e.g., B_{D}) can be represented by a table with two columns. The first column includes sliver collections E₁ that can be received from a user experience, e.g., in response to a user interaction with a user experience. The second column includes E₂ sliver collections that can be matched to sliver collections E₁. Thus, state slivers received from a user experience as part of E₁ can be matched to state slivers included as part of E₂. Matched state slivers from E₂ can then be provided to another user experience. As discussed above, state sliver collections can have the form (target, slivers), so a table-lookup based transformation can be used to transform specific targets to other targets, or specific sliver values to other sliver values, combinations of specific targets and slivers to other targets and values, and so on.

Mathematical Transformations

Mathematical transformations can be utilized that can include mathematical functions that can be applied to state slivers, state sliver collections, state sliver values, and so on. The mathematical functions can be implemented as a built-in set of functions, and can include a variety of different types of known mathematical functions. These can be used to perform certain classes of non-linear transformations, such as projection transformations, e.g., going from Earth coordinates to a flat view, from a perspective view to a flat view, and so on.

In implementations, specific mathematical functions can be specified for specific types of state slivers and/or state sliver collections. For example, a specific mathematical function can be specified for a sliver collection SSC. When the sliver collection SSC is received from a first user experience and the mathematical function is applied, a sliver collection SSC′ results. The sliver collection SSC′ can then be provided to a second user experience, which can use SSC′ to affect one or more changes to the second user experience.

Interpolation Transformations

Interpolation transformation can include data-driven interpolation. For example, pairs of points can be utilized, one point from a source user experience and one point from a destination user experience. These points can be used to create interpolation functions so that a point in the source user experience can be translated to a point in the target user experience. In implementations, interpolation transformation can be used for arbitrary non-linear transformations. For example, interpolation transformation can be used for translating the coordinates of a panorama of a large architectural site to a hand-drawn schematic (e.g., a simpler and not-to-scale version) of the same site.

Declarative Transformations

In implementations, declarative programming techniques can be used to provide an enumeration of transformations between specific kinds of state slivers. For example, such techniques can be used to provide transformations between points in 2D manifolds, points in 2D images (e.g., from a panorama to a flat schematic diagram), between 2D manifolds and 1D representations (e.g., a map and a timeline), between points in 2D manifolds to discrete items (e.g., transforming <latitude, longitude> to an identifier that identifies a geographic location within which a point resides), and so on. For example, a set of built-in sliver-transforming functions that are data driven can be specified declaratively. In implementations, declarative transformations can be defined by a set of interpolation tables and/or mathematical expressions.

The following is an example framework that specifies example ways in which declarative transformations can be applied to transform a source sliver collection to a target sliver collection. According to the framework, state slivers in a state sliver collection can be run through a series of <pattern, transformation specification> rules, where:

Pattern: <E₁ target pattern tp>, <E₁ Sliver ID Sid₁>

Transformation Specification: <Target transformation function ttf, Target transformation data ttd>, <Sliver Transformation Function stf, Sliver Transformation Data std>, <E₂ Sliver ID sid₂>, where:
a. tp is a pattern that can be used (along with Sid) to identify which state sliver to transform. Since a target is a set of property-value assignments (e.g., Name, PageNum, and so on), the pattern can be a set of conditions on these properties (such as Name==“view”).
b. Sid₁ is the ID of a state sliver. In implementations, state slivers can be present as a dictionary in a sliver collection. In implementations, the ID can be the ID index of the dictionary, for example, “region,” “group,” and so on.
c. ttf is the transformation function (examples of which are discussed above and below) to be used to transform the source (E₁) target to the destination (E₂) target.
d. ttd are data parameters that can be provided to the ttf
e. stf is the transformation function to be used to transform the source (E₁) sliver to the destination (E₂) sliver
f. std are data parameters that can be provided to the stf (e.g., interpolation data)
g. sid₂ is the ID of the sliver that is generated as a result of the transformation.

In implementations, target and/or sliver transformation functions (e.g., ttf and/or stf, above) can be user-provided. For example, a user can identify one or more transformation functions using identifiers for the functions. The appropriate function(s) can be looked up in a library using the user-specified identifier(s) and invoked to implement one or more transformations.

Additionally or alternatively, a set of predefined functions can be provided for interpolation and lookup. The following are just a few examples of such predefined functions.
a. Interpolate—this function maps a point in one space (e.g., in a user experience) to a point in another with the same or similar dimensions (e.g., 2D to 2D). Example data for this function includes the type of interpolation (e.g., linear, cubic, and so on), pairs of points to interpolate, and so on.
b. Project—this function maps a point in one space to a space with lower dimensionality (e.g., 2D to 1D). Data can include the type of projection (e.g., spherical to linear, linear to linear, and so on), and parameters to be used for the projection (e.g., camera angles, location coordinates, and so on).
c. Digitize—this function maps a point in a space to an integer value. The integer value can be used to look up a table of values, such as discussed above with respect to the table lookup based transformation. In implementations, data for this function can include a set of spatial regions and their associated integer. The spatial regions can correspond to regions of interest in an image, such as a map image.
d. Lookup—this function can perform a table lookup of a discrete value, such as a string, an enumeration, an integer, and so on. Data for this function can include a table to be used for lookup.
e. Combinations of functions—in implementations, combinations of these and other functions can be applied as part of a transformation. For example, for a particular transformation, a list of functions and data to be used for the functions can be specified. The list of functions can be applied (e.g., in sequence) for the transformation using the data. For instance, an object associated with a region state sliver (discussed above) can be first transformed into a discrete integer value using the “Digitize” function. The discrete integer value can then be used to call a particular state sliver using the “Lookup” function, discussed above.

XSLT Transformations

In implementations, Extensible Stylesheet Language Transformations (XSLT) can be used as a basis for transformation state slivers and/or state sliver collections. For example, extensible markup language (XML) representations of state slivers can be transformed using rules specified in the XSLT World Wide Web Consortium (W3C) specification. In implementations, additional data (the D in B_{D}, discussed above) can be provided as additional XML documents to an XSLT processor.

Transformation Combinations

In implementations, combinations of the transformations discussed herein can be utilized. For example, two or more of the transformation types discussed herein can be specified as a set of transformations. The set of transformations can be applied (e.g., in sequence) to a state sliver and/or a sliver collection.

Multi-Direction Interactions

In implementations, interactions between user experiences can occur via a multidirectional exchange of state slivers. For example, with reference to the user experiences E₁ and E₂ and the broker functionality B_{D} discussed above, a multidirectional interaction between user experiences can be characterized as E₁<->B_{D}<->E₂. For instance, a user can pan on the user experience E₁ while zooming on the user experience E₂. In such a scenario, a multidirectional exchange of state slivers can enable the pan interaction with E₁ to be reflected in E₂, and the zoom interaction with E₂ to be reflected in E₁. In implementations, such interactions can be represented as multiple unidirectional transformations between the user experiences that occur at approximately the same time.

To avoid possible infinite loop scenarios with the multidirectional exchange of state slivers, identifiers for user experiences from which state slivers originate can be maintained through the transformation of the state slivers. For example, if a state sliver originates from the user experience E₁, the E₁ identifier can be maintained with the state sliver when the state sliver is transformed. If the user experience E₁ receives a state sliver that includes the E₁ identifier, this can indicate that the state sliver originated from the user experience E₁ and thus the user experience can ignore the state sliver to avoid a possible infinite loop scenario.

In implementations, user interactions with multiple user experiences can cause a conflict to arise as to which user interaction a particular user experience is to respond to. For example, if a user pans on E₁ while simultaneously panning on E₂ (e.g., using a multi-touch display device), E₁ can receive the direct user input to E₁ in addition to a state sliver generated based on the user panning on E₂. Thus, user input to multiple user experiences can cause a particular user experience to simultaneously receive multiple types of input, e.g., direct user input to the user experience as well as state slivers that result from user input to a different user experience.

In one or more embodiments, policies can be implemented to enable user experiences that receive multiple inputs simultaneously to determine how to respond to the multiple inputs. For example, prioritization policies can be implemented that prioritize certain types of input over other types of input. For instance, a policy can indicate that a user experience is to give a higher priority to direct user input to the user experience than to state slivers received as a result of activities associated with a different user experience, e.g., user interactions and/or scripted events associated with the different user experience. Based on such a policy, a user experience can respond to direct user input while ignoring or delaying a response to a simultaneously received state sliver from a different user experience. Further, if a user experience responds to direct user input to the user experience and ignores a state sliver received from a different user experience, the user experience can subsequently synchronize with a state of the different user experience when the user is finished interacting with the user experience.

These policies are presented for purposes of example only, and a variety of different policies can be implemented in accordance with one or more embodiments. For example, policies can be implemented that give a higher priority to input from certain types of state slivers and/or state slivers received from specific user experiences, then to other forms of input.

Having described example state sliver transformations, consider now a discussion of some example methods in accordance with one or more embodiments.

### Example Methods

Discussed below are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

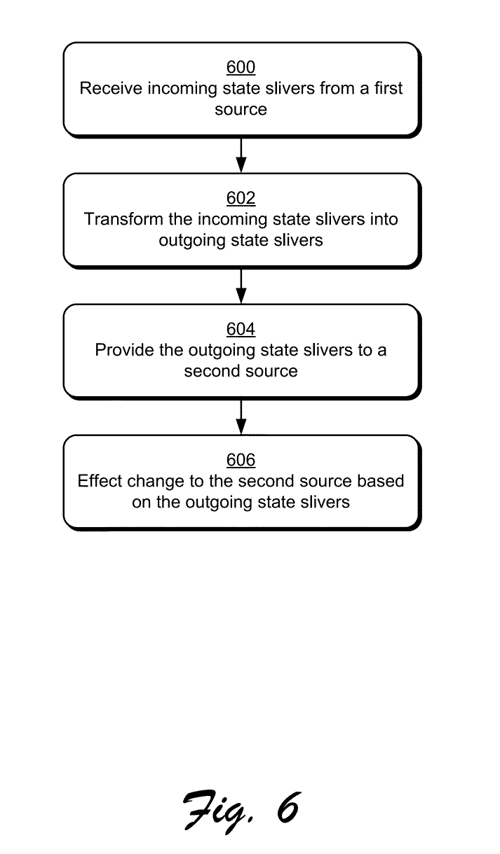

FIG. 6 is a flow diagram that describes steps in a method in accordance with one or more embodiments. Step 600 receives incoming state slivers from a first source. For example, the state slivers can be received by the broker module 128 and/or the experience modules 120 in response to an event associated with another user experience or other external source.

In implementations, the first source can be a software module or data source. As mentioned above, compositions and/or user experiences can be driven by scripts that specify how a composition and/or user experience is to be played, e.g., without human interaction. In implementations, the first source can generate a stream of state slivers that indicate how a particular composition and/or user experience is to be manipulated. Thus, processing a stream of slivers can cause a composition and/or user experience to evolve independent of direct user interaction.

Alternatively or additionally, the slivers can be generated by a user experience, based on a user interaction with a user experience. Examples of a user interaction include user navigation through content (e.g., between locations on a map), a user selection of a selectable item, a user navigation to an instance of content, and so on. Thus, a user interaction with a user experience can cause one or more state slivers to be emitted.

Step 602 transforms the incoming state slivers into outgoing state slivers. For example, the broker module 128 can apply one or more of the transformation rules 130 to the incoming state slivers and/or data included within the state slivers, which can cause outgoing state slivers to be generated. Examples of transformation rules and the application thereof are discussed above. Step 604 provides the outgoing state slivers to a second source. For example, the broker module 128 can provide the outgoing state slivers to one or more of the experience modules 120, the compositions 114, and/or other entity that can utilize information included in the outgoing state slivers.

Step 606 effects change to the second source based on the outgoing state slivers. For example, one or more changes can be made to the user experience 116 based on the outgoing state slivers. Examples of interaction between user experiences based on the emission and processing state slivers are discussed in detail elsewhere herein.

While example scenarios are discussed with reference to interaction between two user experiences, this is not intended to be limiting. For example, in implementations a state sliver emitted by one user experience can be processed to generate a processed state sliver, which can be provided to multiple other user experiences, external processes, and/or data destinations. Alternatively or additionally, a state sliver emitted by one user experience can be processed into multiple different other state slivers, which can be provided to multiple other user experiences, external processes, and/or data destinations. Thus, techniques discussed herein can be implemented to enable interactions between multiple (e.g., more than two) user experiences and/or other entities.

FIG. 7 is a flow diagram that describes steps in a method in accordance with one or more embodiments. In implementations, the method describes example ways in which state slivers can be used to change aspects of a user experience or other entity.

Step 700 parses an incoming stream of state slivers to determine state sliver updates. For example, the state parser module 502 can receive a state stream from an external source (e.g., a user experience module) and can determine updates to logical state information included as part of the state slivers and/or state sliver collections from the state stream.

Step 702 aggregates the state sliver updates into updated state information for a user experience. For example, the integration and interpolation module 504 can apply algorithms and/or transformations (examples of which are discussed above) to information included in the state sliver updates to generate the updated state information. Additionally or alternatively, the integration and interpolation module 504 can access the shared resources 516 to perform various processing on the state sliver updates.

Step 704 interpolates intermediate values for a logical state of the user experience. As discussed above, the intermediate values can correspond to transitional logical state for a user experience that can occur in between or outside of logical states specified in state slivers and/or state sliver updates. In implementations, step 704 can be optional.

Step 706 calls user experience functionality to manipulate a logical state of the user experience based on the updated state information and the intermediate values. For example, the integration and interpolation module 504 can call the experience functionalities 514 with information that describes the updated state information. The experience functionalities 514 can use the information to change one or more aspects of an associated user experience, e.g., to conform to an evolution of small state indicated by the updated state information.

FIG. 8 is a flow diagram that describes steps in a method in accordance with one or more embodiments. In implementations, the method describes example ways in which state slivers can be generated (e.g., by a user experience module) and emitted to an external source.

Step 800 registers to receive events from a user experience. For example, the event detection and differencing module 506 can register with the experience functionalities 514 to receive events generated by a user experience. Such events can be based on user interaction with the user experience, scripted events associated with a user experience, events initiated by other entities that affect a user experience, and so on.

Step 802 detects a change to a logical state of the user experience. For example, the event detecting and differencing module 506 can receive an event from the experience functionalities 514 based on a scripted and/or user interaction with an associated user experience. Step 804 assembles differential state information based on the change to the logical state. For example, the differential state information can be generated by comparing a current logical state of the user experience, as indicated by the change to the logical state, with a previous version of the logical state. Thus, the differential state information can represent a difference between two or more logical states of the user experience, e.g., what aspects of the user experience have changed between the logical states.

Step 806 generates outgoing state slivers using the differential state information. For example, the state generator module 508 can apply the differential state information to standardized and/or customized state slivers to generate a collection of outgoing state slivers. Step 808 emits a state stream that includes the outgoing state slivers. For example, the state generator module 508 can emit the state stream for receipt by various external entities, such as the broker module 128, the experience module 120, and/or other entities that can utilize the outgoing state slivers to perform one or more tasks. In implementations, other information can also be added to the state stream in addition to the outgoing state slivers, such as timing information, interpolation information, and so on.

Having described example methods, consider now a discussion of some example implementations for partial updates to state slivers in accordance with one or more embodiments.

Partial Updates to State Slivers

In implementations, state slivers and/or state sliver collections can be associated with a partial attribute (e.g., a Boolean property) that can be used to indicate whether all or part of the state of a target user experience is to be determined based on the state slivers and/or state sliver collections. In implementations, the default value for a partial attribute of a state sliver collection received from a source user experience is “false” such that the payload of the state sliver collection (examples of which are discussed above) can be used to determine the entire state of a target user experience. The following describes an example method in which the partial attribute can be utilized.

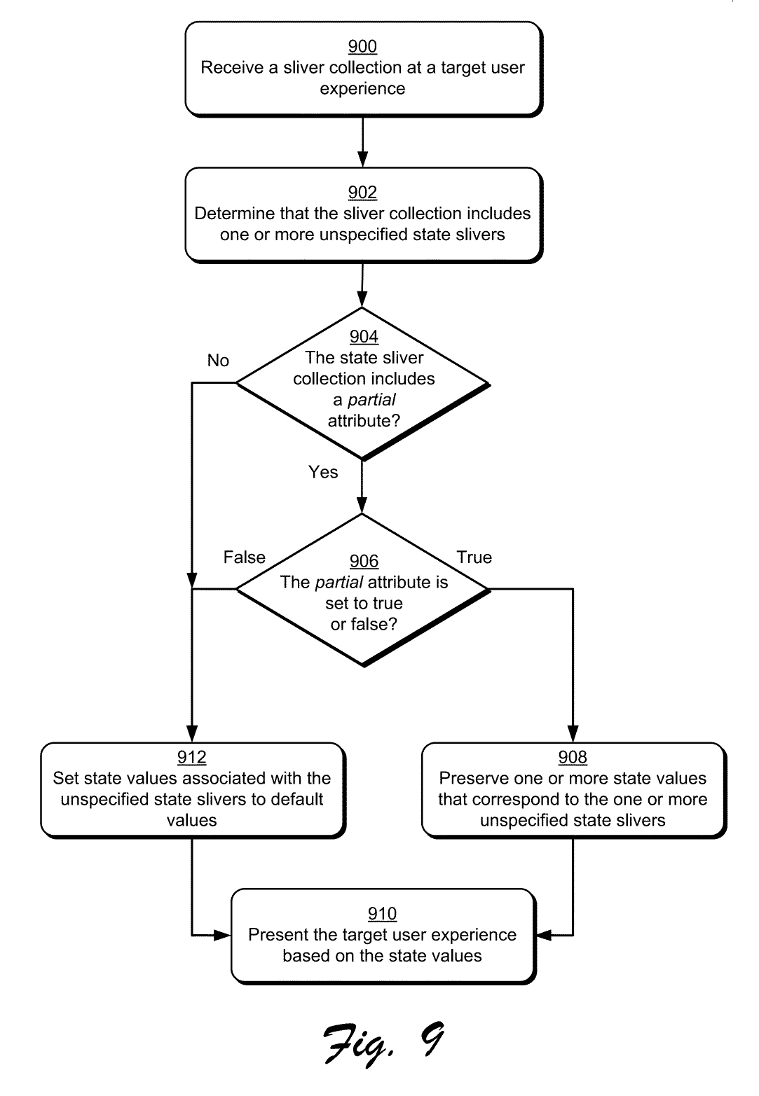

FIG. 9 is a flow diagram that describes steps in a method in accordance with one or more embodiments. Step 900 receives a sliver collection at a target user experience. For example, a sliver collection can be received from the broker module 128 in response to one or more events associated with a source user experience.

Step 902 determines that the sliver collection includes one or more unspecified state slivers. As discussed above, state slivers can include values that can be used to determine a state of a target user experience. Thus, the received state sliver collection may be missing one or more state slivers that can be used to determine the state of the target user experience.

Step 904 ascertains whether the state sliver collection includes a partial attribute. If the state sliver collection includes a partial attribute (“Yes”), step 906 determines whether the partial attribute is set to true or false. If the partial attribute is set to true (“True”), step 908 preserves one or more state values that correspond to the one or more unspecified state slivers. For example, existing values for one or more states of the target user experience can be preserved. Step 910 presents the target user experience based on the state values. For example, the target user experience can be presented as part of a composition using the state values.

Returning to step 906, if the partial attribute is set to false (“False”), step 912 sets state values associated with the unspecified state slivers to default values. In implementations, a user experience can maintain default values for its various states. The user experience can use the default values to specify states that are not specified by a received state sliver and/or state sliver collection. The process then proceeds to step 910 which presents the target user experience based on the state values.

Returning to step 904, if the state sliver collection does not include a partial attribute (“No”), the process proceeds to step 912 which sets state values associated with the unspecified state slivers to default values.

Having described example implementations for partial updates to state slivers, consider now an example system and device in accordance with one or more embodiments.

### Example System and Device

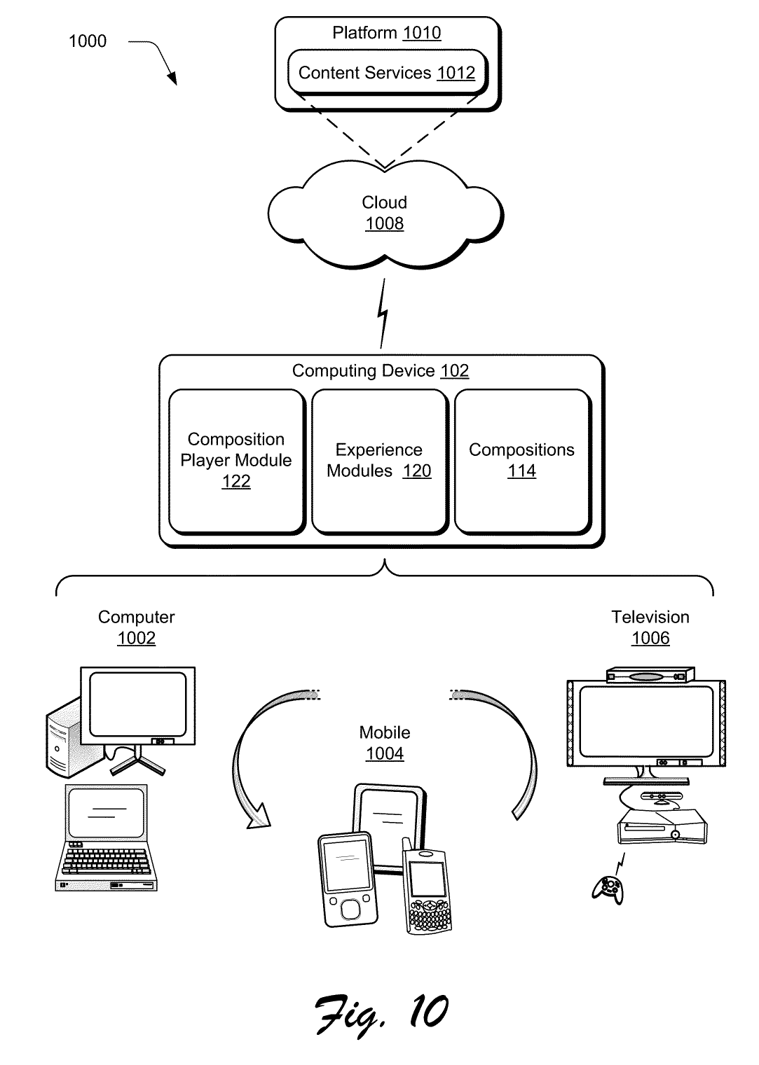

FIG. 10 illustrates an example system 1000 that includes the computing device 102 as described with reference to FIGS. 1 and 9. The example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link. In one or more embodiments, this interconnection architecture enables functionality to be delivered across multiple devices to provide a common and seamless experience to a user of the multiple devices. Each of the multiple devices may have different physical attributes and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 1002, mobile 1004, and television 1006 uses. Each of these configurations includes devices that may have generally different constructs and capabilities, and thus the computing device 102 may be configured according to one or more of the different device classes. For instance, the computing device 102 may be implemented as the computer 1002 class of a device that includes a personal computer, desktop computer, a multi-screen computer, laptop computer, netbook, and so on.

The computing device 102 may also be implemented as the mobile 1004 class of device that includes mobile devices, such as a mobile phone, portable music player, portable gaming device, a tablet computer, a multi-screen computer, and so on. The computing device 102 may also be implemented as the television 1006 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 1008 includes and/or is representative of a platform 1010 for content services 1012. The platform 1010 abstracts underlying functionality of hardware (e.g., servers) and software resources of the cloud 1008. The content services 1012 may include applications and/or data that can be utilized while computer processing is executed on servers that are remote from the computing device 102. Content services 1012 can be provided as a service over the Internet and/or through a subscriber network, such as a cellular or Wi-Fi network.

The platform 1010 may abstract resources and functions to connect the computing device 102 with other computing devices. The platform 1010 may also serve to abstract scaling of resources to provide a corresponding level of scale to encountered demand for the content services 1012 that are implemented via the platform 1010. Accordingly, in an interconnected device embodiment, implementation of functionality described herein may be distributed throughout the system 1000. For example, the functionality may be implemented in part on the computing device 102 as well as via the platform 1010 that abstracts the functionality of the cloud 1008, as shown through inclusion of various functionalities the computing device 102.

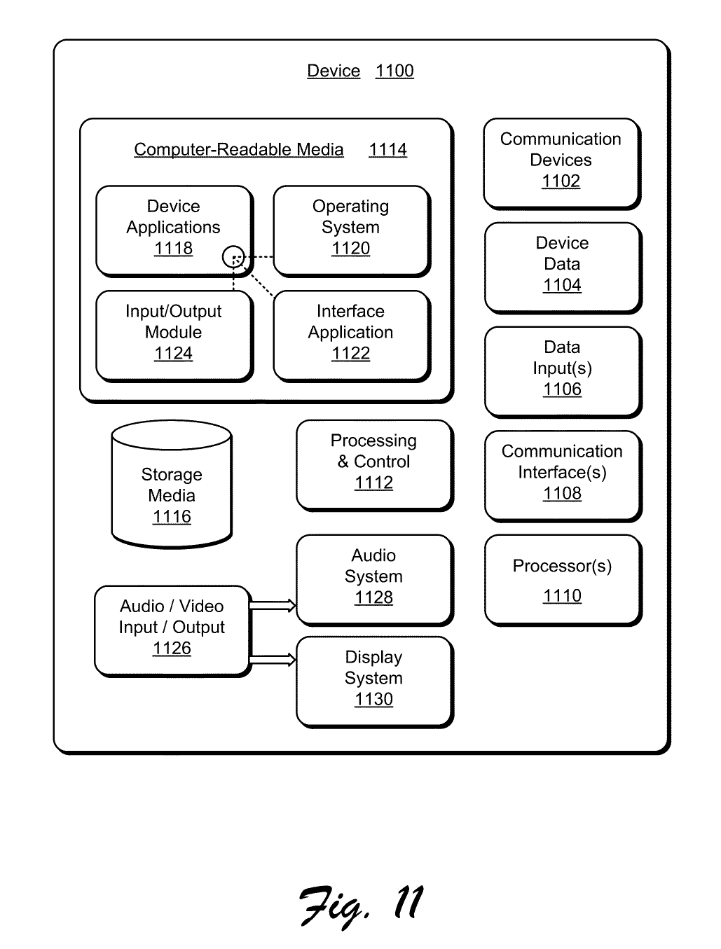

FIG. 11 illustrates various components of an example device 1100 that can be implemented as any type of computing device as described with reference to FIGS. 1 and 10 to implement embodiments of the techniques described herein. Device 1100 includes communication devices 1102 that enable wired and/or wireless communication of device data 1104 (e.g., received data, data that is being received, data scheduled for broadcast, data packets of the data, etc.). The device data 1104 or other device content can include configuration settings of the device, media content stored on the device, and/or information associated with a user of the device. Media content stored on device 1100 can include any type of audio, video, and/or image data. Device 1100 includes one or more data inputs 1106 via which any type of data, media content, and/or inputs can be received, such as user-selectable inputs, messages, music, television media content, recorded video content, and any other type of audio, video, and/or image data received from any content and/or data source.

Device 1100 also includes communication interfaces 1108 that can be implemented as any one or more of a serial and/or parallel interface, a wireless interface, any type of network interface, a modem, and as any other type of communication interface. The communication interfaces 1108 provide a connection and/or communication links between device 1100 and a communication network by which other electronic, computing, and communication devices communicate data with device 1100.

Device 1100 includes one or more processors 1110 (e.g., any of microprocessors, controllers, and the like) which process various computer-executable instructions to control the operation of device 1100 and to implement embodiments of the techniques described herein. Alternatively or in addition, device 1100 can be implemented with any one or combination of hardware, firmware, or fixed logic circuitry that is implemented in connection with processing and control circuits which are generally identified at 1112. Although not shown, device 1100 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1100 also includes computer-readable media 1114, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1100 can also include a mass storage media device 1116.

Computer-readable media 1114 provides data storage mechanisms to store the device data 1104, as well as various device applications 1118 and any other types of information and/or data related to operational aspects of device 1100. For example, an operating system 1120 can be maintained as a computer application with the computer-readable media 1114 and executed on processors 1110. The device applications 1118 can include a device manager (e.g., a control application, software application, signal processing and control module, code that is native to a particular device, a hardware abstraction layer for a particular device, etc.). The device applications 1118 also include any system components or modules to implement embodiments of the techniques described herein.

In this example, the device applications 1118 include an interface application 1122 and an input/output module 1124 that are shown as software modules and/or computer applications. The input/output module 1124 is representative of software that is used to provide an interface with a device configured to capture inputs, such as a touchscreen, track pad, camera, microphone, and so on. Alternatively or in addition, the interface application 1122 and the input/output module 1124 can be implemented as hardware, software, firmware, or any combination thereof. Additionally, the input/output module 1124 may be configured to support multiple input devices, such as separate devices to capture visual and audio inputs, respectively.

Device 1100 also includes an audio and/or video input-output system 1126 that provides audio data to an audio system 1128 and/or provides video data to a display system 1130. The audio system 1128 and/or the display system 1130 can include any devices that process, display, and/or otherwise render audio, video, and image data. Video signals and audio signals can be communicated from device 1100 to an audio device and/or to a display device via an RF (radio frequency) link, S-video link, composite video link, component video link, DVI (digital video interface), analog audio connection, or other similar communication link. In an embodiment, the audio system 1128 and/or the display system 1130 are implemented as external components to device 1100. Alternatively, the audio system 1128 and/or the display system 1130 are implemented as integrated components of example device 1100.

### CONCLUSION

Techniques for manipulation of user experience state are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method, comprising:
detecting a change to a logical state of a user experience;
generating at least one state sliver that includes state information about the change to the logical state of the user experience; and
emitting a state stream that includes the at least one state sliver for receipt by one or more external entities.

2. A method as described in claim 1, wherein the change to the logical state occurs in response to a user interaction with the user experience.

3. A method as described in claim 1, wherein the change to the logical state occurs in response to a scripted event associated with the user experience.

4. A method as described in claim 1, wherein the state sliver is part of a standardized set of state slivers that may be utilized by different entities to receive and propagate state information.

5. A method as described in claim 1, wherein the state information includes attributes of content associated with the user experience.

6. A method as described in claim 1, wherein said generating comprises determining a difference between a current logical state of the user experience and a previous logical state of the user experience.

7. A method as described in claim 1, wherein said generating comprises including the state sliver as part of a sliver collection that includes a target property that indicates a user experience property to which the sliver collection is targeted.

8. A method as described in claim 7, wherein the sliver collection includes at least one other state sliver that includes other state information for the user experience.

9. A method as described in claim 1, wherein said emitting comprises providing the state stream to a broker module that is configured to:
apply at least one transformation rule to the state sliver to generate transformed state information; and
provide the transformed state information to at least one external entity.

10. A computer-implemented method, comprising:
receiving one or more incoming state slivers from a first source, the one or more state slivers including logical state information for the first source;
processing the one or more state slivers based on the logical state information to generate one or more outgoing state slivers; and
providing the one or more outgoing state slivers for receipt by a second source to enable the second source to effect one or more changes to the second source based on state information from the one or more outgoing state slivers.

11. A method as described in claim 10, wherein the event comprises one or more of a scripted event or a user interaction with content associated with the first source.

12. A method as described in claim 10, wherein said receiving comprises receiving the one or more state slivers as part of a state sliver collection that includes multiple state slivers, each of the multiple state slivers being of a different type and including different state information for the first source.

13. A method as described in claim 10, wherein the second source comprises a user experience associated with a particular type of content, and wherein the one or more changes comprise one or more changes to an instance of the particular type of content.

14. A method as described in claim 10, wherein said processing comprises applying at least one transformation rule from a set of transformation rules to the one or more state slivers to generate the one or more outgoing state slivers.

15. A method as described in claim 10, wherein said providing comprises providing the one or more processed state slivers as part of a state sliver collection that includes a partial attribute, the partial attribute indicating whether state conditions for the second source that are not specified in the state sliver collection are to be preserved according to previous state conditions or are to be set to default values.

16. A computer-implemented method, comprising:
parsing an incoming stream of state slivers to determine one or more updates to information included in the state slivers;
aggregating the one or more updates into updated state information for a user experience; and
calling one or more user experience functionalities to manipulate a logical state of the user experience based on the updated state information.

17. A method as described in claim 16, wherein the incoming stream of state slivers are included as part of one or more sliver collections included in a state stream received from an external source.

18. A method as described in claim 16, wherein said aggregating comprises applying one or more transformation rules to the state information.

19. A method as described in claim 16, wherein said aggregating comprises accessing one or more external resources to process at least a portion of the information included in the state slivers to produce at least a portion of the updated state information.

20. A method as described in claim 16, further comprising:
interpolating, prior to said calling, one or more intermediate values for the logical state of the user experience, the intermediate values corresponding to a logical state for the user experience not specified in the incoming stream the state slivers; and
providing the intermediate values to the one or more user experience functionalities to be used to manipulate at least a portion of the logical state of the user experience.
